(19) United States
(12) Patent Application Publication
(10) Pub. No.: US 2022/0248612 A1
(43) Pub. Date: Aug. 11, 2022

(54) Control of Pathogens by Foliar Spraying with CO2-Infused Water

(71) Applicant: CO2 Gro, Inc., Toronto (CA)

(72) Inventor: John Archibald, Grimsby (CA)

(21) Appl. No.: 17/609,474

(22) PCT Filed: Apr. 22, 2020
(86) PCT No.: PCT/CA2020/050527

§ 371 Date: Nov. 8, 2021

Related U.S. Application Data
(60) Provisional application No. 62/846,837, filed on May 13, 2019.

(51) Int. Cl. A01G 7/02; A01G 7/06; A01N 59/04; A01N 25/02

(52) U.S. Cl. CPC A01G 7/02; A01N 25/02; A01N 59/04; A01G 7/06

(57) ABSTRACT

Pathogen reduction is highly desirable when growing plants. Foliar spraying with CO₂-infused water has been found to reduce the number of plant pathogens, with higher frequency of foliar spraying reducing the number of plant pathogens by greater amounts. However, too frequent foliar spraying with CO₂-infused water may harm the plant, the frequency of foliar spraying at which this occurs depending on the species of plant. A balance is found at which the frequency of foliar spraying is high enough to effectively control plant pathogens but not so high as to harm the plant. This balance is dependent on the species of plant.

### FIELD OF INVENTION

This invention relates to gardening, and more particularly to control of plant pathogens.

### BACKGROUND

Foliar feeding is a method of feeding plants by applying liquid fertilizer directly to their leaves rather than through their roots. Plants are able to absorb essential elements through their leaves. The absorption takes place through their stomata and also through their epidermis. Transport is usually faster through the stomata, but total absorption may be as great through the epidermis. Foliar feeding was earlier thought to damage tomatoes, but has now become standard practice. Addition of a spray enhancer can help nutrients stick to the leaf and then penetrate the leaves.

It would be desirable to provide improved methods and devices for controlling or even eliminating many plant pathogens. It would be desirable for such methods and devices to be relatively convenient, safe and simple to apply. It would be particularly desirable for such methods and devices to be effective with most or all higher leafy plants.

### SUMMARY

The present invention provides novel and effective methods and devices for controlling pathogens commonly found on plant leaves, particularly unicellular pathogens.

The methods of the present invention are effective with virtually all photosynthetic plant species having leaves or other surfaces capable of receiving foliar sprays, particularly higher plants. “Higher” plants include all plant species having true stems, roots, and leaves, and thus exclude lower plants, e.g. yeasts, algae and molds.

The present invention provides substantial benefits in reducing the number of pathogens located on the leaves of plants, especially leafy vegetables and flowers. By foliar spraying with CO₂-infused water at specific frequencies and for specific durations, each of which may be dependent on the particular plant and the particular pathogen being controlled, rapid changes in pH on the surface of the plant are produced. This produces an inhospitable environment for the pathogens, and their number is greatly reduced or even eliminated. The frequency and duration of foliar spraying with the CO₂-infused water must not be too high, or yellowing of the leaves may occur. If the frequency and duration of foliar spraying are determined properly, as described herein, foliar spraying following this regimen may reduce pathogens without significantly harming the plant. This results in healthier plants, which may reduce spoilage, improve plant yield, and/or reduce growth time.

### DETAILED DESCRIPTION OF THE PREFERRED EMBODIMENTS

Foliar spraying with CO₂-infused water has been documented to enhance plant growth significantly in comparison to other commercial CO₂ enhancement methods. Unexpected during growth trials was a reduction in bacterial, fungal, and insect loads preying on plants treated with CO₂-infused water.

Experiments were conducted to consider the effect of foliar spraying with CO₂-infused water. Three pathogenic organisms and one predator organism were considered in this experimentation: Escherichia coli (Bacteria), Leveillula taurica (Powdery Mildew), Fusarium oxysporum (Fungi), and Acyrthosiphon pisum (aphid).

Escherichia coli Results

Two experiment were conducted.

In the first, ten replicate nutrient plates were maintained for 5 days. All plates were inoculated with E. coli via streaking from a stock culture. Five plates were allowed to grow for a 5 day duration without treatment. The remaining five plates were treated with CO₂ infused water (800 ppm) via a spray bottle. Plates were sprayed daily every 15 minutes for a 3 hour interval. Bacterial count estimations were conducted each day post inoculation of the 5 day experiment.

In the second experiment, plant leaves were used in the place of nutrient agar plates. Twenty leaves on four plants were infected with E. coli. Five leaves were allowed to grow for a 5 day duration without treatment. The remaining five leaves were treated with CO₂ infused water (800 ppm) via a spray bottle. Leaves were sprayed daily every 15 minutes for a 3 hour interval. Bacterial count estimations were conducted on days 3 and 5 using an agar paddle plate inoculated with plant leaves.

In both experiments, results were compared statistically with a Mann Whitney U test for equal medians using Day 5 data. This non-parametric test was selected because bacterial abundances were categorical rather than ordinal. Statistical comparisons found significant differences in both experiments (p=0.003978 and p=0.0070887). These results are consistent with the hypothesis that CO₂ infused foliar spray inhibits the growth of E. coli.

Fusarium oxysporum Results

Two experiment were conducted.

In the first, ten replicate potato agar plates were maintained for 5 days. All plates were inoculated with F. oxysporum via streaking from a stock culture. Five plates were allowed to grow for a 5 day duration without treatment. The remaining five plates were treated with CO₂ infused water (800 ppm) via a spray bottle. Plates were sprayed daily every 15 minutes for a 3 hour interval. Fungal colony forming unit (CFU) estimations were conducted each day post inoculation of the 5 day experiment.

In the second experiment, plant leaves were used in the place of potato agar plates. Twenty leaves on four pepper plants were infected with F. oxysporum. Five leaves were allowed to grow for a 5 day duration without treatment. The remaining five leaves were treated with CO₂ infused water (800 ppm) via a spray bottle. Leaves were sprayed daily every 15 minutes for a 3 hour interval. Fungal CFU estimations were conducted on days 3 and 5 using an agar paddle plate inoculated with plant leaves.

In both experiments, results were compared statistically with a Mann Whitney U test for equal medians using Day 5 data. This non-parametric test was selected because bacterial abundances were categorical rather than ordinal. Statistical comparisons found significant differences in both experiments (p=0.010418 and p=0.009937). These results are consistent with the hypothesis that CO₂ infused foliar spray inhibits the growth of the fungus F. oxysporum.

Acyrthosiphon pisum Results

A single experiment was conducted with the aphid Acyrthosiphon pisum. Twenty replicate pepper plants were maintained for 5 days. All plants were inoculated with 20 aphids. Ten plants were allowed to grow for the 5 day duration without treatment. The remaining 10 plants were treated with CO₂ infused water (800 ppm) via a spray bottle. Plants were sprayed daily every 15 minutes for a 3 hour interval. Aphid counts were conducted each day of the 5 day experiment.

Results were compared statistically with a Student's t-Test for equal means using Day 5 data. A significant difference (p=9.5959*E-21) was identified between control and CO₂ infused foliar spray treated plants. These results are consistent with the hypothesis that CO₂ infused foliar spray retards insect grazers like Acyrthosiphon pisum.

Leveillula taurica Results

A single long term experiment was conducted with the Powdery Mildew, Leveillula taurica. The organism is an obligate parasite preventing experimentation with plate agar cultures. The experiment consisted of three treatments using 8 replicate pepper plants. The treatments consisted of an untreated control, plants grown in a CO₂ enriched atmosphere (1200 ppm), and plants treated with CO₂ infused water (800 ppm). All plants were exposed to Leveillula taurica collected from wild plants. The inoculation procedure was as follows. Collected leaves were dried and ground. Ground leaves were infused in water for 24 hours and then filtered. Filtered water was spray on test plants to complete fungal infection. Plants were allowed to grow for 21 days. The first signs of fungal infection were recorded for each test group and the number of days survived were recorded for each plant.

Results were compared statistically using an ANOVA and Tukey's Post-Hoc test using the “Days Survived” data. The ANOVA identified a significant difference among experimental treatments (p=1.018E-9). Further analysis with the Tukey's Post-Hoc test identified the significant differences occurred between CO₂ infused foliar spray treated plants and all other treatments. No significant differences were identified between the control plants and plants grown in CO₂ enriched atmosphere. These results are consistent with the hypothesis that CO₂ infused foliar spray treatment inhibits the growth of Powdery Mildew, Leveillula taurica.

Method of One Embodiment of the Invention

Frequent fluctuations in pH from acidic to basic conditions and back over short time intervals produce a hostile environment for pathogens. The inventors theorize that this is the reason why frequent foliar spraying with CO₂-infused water harms pathogens. The infusion of CO₂ into water reduces the pH of the water through the production of carbonic acid. The CO₂-infused water used in the experiments described above is typically below a pH of 5. As the gases in the infused water equilibrate with the atmosphere, the water gradually returns to a pH of 7.

The production of carbonic acid is also a function of the hardness of the water. The process is enhanced in soft water and muted in hard water.

Ideally, this frequency would be as high as possible in order to eliminate as many pathogens as possible. However, during experimentation, yellowing of some plants leaves was observed as the frequency of foliar spraying became too high. This may be due to the maximum capability of the plant to synthesize carbon. Foliar spraying should stop when the plant is “full” of carbon dioxide, then resume after it subsides a bit.

The variability of frequency of foliar spraying depends on the species of plant. The inventors theorize that the frequency of foliar spraying with CO₂-infused water may depend on the thickness or waxiness of the leaf cuticle. For example, plants in doctors' offices, which tend to have quite waxy leaves, can probably be sprayed with a high frequency.

The first step of the method is then to determine the optimal frequency of foliar spraying with CO₂-infused water for a plant species in question. Preferably, the water used as the initial source should have a hardness below 50 ppm and a pH of 7 or higher. Harder or more acidic water can also be used as a source, albeit to less effect. The water is then infused to 70-100% CO₂ saturation. This should cause the pH of the water to drop to below 5. Foliar spraying of one or more sample plants of this plant species is then carried out with this CO₂-infused water at 60-minute intervals for a 3-hour period. The frequency of foliar spraying is then shortened by 15 minutes, and 3 spraying intervals are carried out. This cycle of shortening the frequency and carrying out foliar spraying continues until either the health of the plant is determined to decline below a threshold or a 15-minute spray interval frequency is reached, whichever occurs first. This final frequency of foliar spraying is determined to be the optimal frequency.

As a coarse measure, the health of the plant can be determined to have declined below the threshold when yellowing of the plant leaves is observed. Alternatively, a certain amount of yellowing may be acceptable if measured pathogen levels are found to decrease by a predetermined amount. The degree of acceptable yellowing and the predetermined amount of pathogen reduction are determined by the experimenter.

Another method of determining the health of the plant is to measure the level chlorophyll A production within the plant. A baseline measurement of chlorophyll A is taken in its intended growth environment. Repeated foliar spraying as described above, with gradually shortening intervals between spraying intervals, is then carried out. Every hour the chlorophyll A level within the plant is measured. The health of the plant is determined to decline below the threshold when the chlorophyll A level of the plant starts to decline.

Example Optimal Frequencies are Given in the Experiments Described Above.

Once the optimal frequency of foliar spraying with CO₂-infused water is determined, foliar spraying of a plant of the plant species particular to the optimal frequency is carried out. CO₂-infused water may be sprayed or misted in a manner so as to cover an entire leaf or plant, or planted area. If desired, spraying or misting can be designed so that the CO₂-infused water additionally covers the underside of the leaf or plant.

The water is infused with CO₂ under conditions sufficient to result in CO₂ concentrations in water in excess of atmospheric concentration (typically expressed as 250-350 milligrams CO₂ per liter air (mg/l)). Accordingly, in certain embodiments of the invention, water is infused with CO₂ under conditions sufficient to result in CO₂ concentrations of greater than about 0.37 mg CO₂/liter water; greater than about 0.4 mg CO₂/liter; greater than about 0.5 mg CO₂/liter; greater than about 0.6 mg CO₂/liter; greater than about 0.7 mg CO₂/liter; greater than about 0.8 mg CO₂/liter; greater than about 0.9 mg CO₂/liter; greater than about 1.0 mg CO₂/liter; greater than about 1.2 mg CO₂/liter; greater than about 1.5 mg CO₂/liter; greater than about 1.8 mg CO₂/liter; or greater than about 2.0 mg CO₂/liter (aq.). In certain embodiments, the concentration of CO₂ is controlled so as to fall within a desired range. Accordingly, in certain embodiments of the invention, water is infused with CO₂ under conditions sufficient to result in CO₂ concentrations falling within the range of about 0.37 mg/l to about 2400 mg/l; about 0.6 mg/l to about 2200 mg/l; about 0.7 mg/l to about 2000 mg/l; about 0.8 mg/l to about 2000 mg/l; or within the range of about 1.0 mg/l to about 2000 mg/l.

By coupling CO₂ infusion technology with foliar misting, the present invention allows control of plant pathogens. This provides healthier and more robust plants, which may increase plant yield both individually and as a crop.

The embodiment of the invention described above used particular starting intervals and amounts by which the interval between foliar sprayings is decreased in order to determine the optimal frequency. These are example starting intervals and amounts of interval shortening used by the inventors and found to be effective. Alternate starting intervals and amounts of interval shortening could be used. The broad idea in determining the optimal frequency of foliar spraying of a plant species with CO₂-infused water is to determine the highest such frequency which does not significantly harm the plant, for example the highest frequency of foliar spraying which maintains maximum chlorophyll A levels within sample plants of that plant species.

The embodiments presented are exemplary only and persons skilled in the art would appreciate that variations to the embodiments described above may be made without departing from the spirit of the invention. The scope of the invention is solely defined by the appended claims.

I/We claim:

1. A method of reducing pathogens on plant leaves, comprising:
determining the optimal frequency of foliar spraying a plant species with CO₂-infused water; and
foliar spraying a plant of that plant species with CO₂-infused water at the determined optimal frequency.

2. The method of claim 1 wherein determining the optimal frequency of foliar spraying with CO₂-infused water comprises determining the optimal frequency as the highest frequency which does not harm a sample plant of the plant species.

3. The method of claim 1 wherein determining the optimal frequency of foliar spraying with CO₂-infused water comprises:
selecting a low frequency of foliar spraying;
foliar spraying a sample plant of the plant species with CO₂-infused water at the selected frequency;
if no yellowing of leaves of the sample plant is observed, increasing the frequency of foliar spraying;
repeating the preceding two steps until yellowing of the leaves is observed; and
determining the optimal frequency to be the final frequency of foliar spraying used.

4. The method of claim 1 wherein determining the optimal frequency of foliar spraying with CO₂-infused water comprises:
selecting a low frequency of foliar spraying;
foliar spraying a sample plant of the plant species with CO₂-infused water at the selected frequency;
if no or acceptable yellowing of leaves of the plant is observed, increasing the frequency of foliar spraying;
repeating the preceding two steps until unacceptable yellowing of the leaves is observed; and
determining the optimal frequency to be the final frequency of foliar spraying used.

5. The method of claim 1 wherein determining the optimal frequency of foliar spraying with CO₂-infused water comprises:
measuring a baseline level of chlorophyll A within a sample plant of the plant species;
selecting a low frequency of foliar spraying;
foliar spraying sample plants of the plant species with CO₂-infused water at the selected frequency;
measuring a current level of chlorophyll A within the sample plant;
if the measured current level of chlorophyll A within the sample plant is the same as the baseline level, increasing the frequency of foliar spraying;
repeating the preceding three steps until the measured current level of chlorophyll A of the sample plant is below the baseline level; and
determining the optimal frequency to be the final frequency of foliar spraying used.
